(19) United States
(12) Patent Application Publication
(10) Pub. No.: US 2011/0008533 A1
(43) Pub. Date: Jan. 13, 2011

(54) COATER AND METHOD OF MANUFACTURING PLASTIC LENS

(75) Inventors: Koichi Sakai, Tokyo (JP); Takako Ishizaki, Tokyo (JP); Katsuaki Uchida, Shinjuku-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: HOYA CORPORATION, Tokyo (JP)

(21) Appl. No.: 12/933,813

(22) PCT Filed: Mar. 4, 2009
(86) PCT No.: PCT/JP2009/054047

§ 371 Date: Sep. 21, 2010

(30) Foreign Application Priority Data
Mar. 27, 2008 (JP) 2008-084663

(51) Int. Cl. B05D 5/06; B05C 5/00

(52) U.S. Cl. 427/162; 118/50

(57) ABSTRACT

A coating device includes a treatment tank capable of being hermetically-sealed, a substrate holder contained in the treatment tank, a rotation mechanism for rotating the substrate holder, a nozzle for spraying a coating material to a substrate held by the substrate holder, and a partial pressure reducer for reducing partial pressure of a volatile component derived from the coating material inside the treatment tank. The coating device not only prevents dust from entering a treatment tank by sealing the treatment tank hermetically, but also reduces unevenness in thickness of the coating film in the case where the coating treatment is performed to a plurality of lenses.

### TECHNICAL FIELD

The present invention relates to a coating device, such as a spin coating apparatus, for coating a material such as a protective film, a hard coat or the like to the surface of a plastic lens for spectacles, for example.

### BACKGROUND FIELD

There has been known a technology in which a spin coating method is adopted as a wet process applied to a surface of a substrate such as a lens (see, for example, Patent Documents 1 and 2).

Patent Document 1 proposes that, in a device for spraying a coating material upward from a nozzle arranged under a substrate to be coated such as a lens, the nozzle is tilted from the vertical direction so that the outlet port of the nozzle is prevented from being stained by the coating material.

Further, Patent Document 2 discloses a method in which a coating liquid is spayed in the form of mist.

By employing the spin coating methods proposed in Patent Documents 1 and 2, the coating material can be coated on the substrate in a manner in which unevenness in thickness of the coating film is reduced.

[Patent Document 1] Japanese Unexamined Patent Application Publication No. 09-094519

[Patent Document 2] Japanese Unexamined Patent Application Publication No. 2000-041745

### DISCLOSURE OF THE INVENTION

### Problem To Be Solved By the Invention

In the case where the spin coating methods described above are employed to coat a substrate such as a lens, if dust enters from the outside, a defect will be formed in the coating film, and therefore peeling and/or cracking of the coating film initiated from the defect will be caused. Thus, it is preferred that the spin coating is performed in a hermetic environment. Particularly, it is preferred that a plastic lens, which is a transparent body, is coated in a clean hermetic environment.

However, if the spin coating is performed in a hermetic environment, a coating film having sufficient thickness can not be obtained. This is because a treatment tank for performing coating is full of solvent vapor vaporized from the coating material and the surface being coated. For example, in the case where the spin coating method is used to successively perform surface treatment to a plurality of lenses, the treatment tank will be full of the solvent vapor after several lenses (specifically, three to five lenses) have been coated. In such a condition, thickness of the coating film will decreases after several lenses have been coated, and as a result, good film thickness distribution can not be obtained in the case where the coating treatment is performed to a plurality of lenses.

Though it is not quite clear, it is presumed that the reason for this phenomenon is because that, in the condition where the treatment tank is full of the solvent vapor, the surface to be coated is covered with vaporized solvent before being coated with the coating material, and therefore a solvent film at the molecular level is formed on the surface. Since the solvent film at the molecular level is formed on the surface to be coated, state of the surface changes, and therefore the coating film changes even if the coating treatment is performed in the same condition.

In view of the aforesaid problems, it is an object of the present invention to not only prevent dust from entering the treatment tank by sealing the treatment tank hermetically, but also reduce unevenness in thickness of the coating film in the case where the coating treatment is performed to a plurality of lenses.

### Means For Solving the Problem

A coating device according to an aspect of the present invention includes a treatment tank capable of being hermetically-sealed; a substrate holder contained in the treatment tank and disposed in a rotatable manner; a nozzle for spraying a coating material to a substrate held by the substrate holder; and a partial pressure reducer for reducing partial pressure of a volatile component derived from the coating material inside the treatment tank.

Note that, in the description of the present invention, the expression “hermetically-sealed” means a state in which unexpected materials such as liquid, gas and dust are prevented from entering from the outside. Thus, the concept of “hermetically-sealed” does not include the case where a liquid (specifically, the coating material), a gas (specifically, an introduced gas) and/or the like is purposely introduced from the outside into the treatment tank, and the case where a liquid (specifically, an excess coating material), a gas (specifically, a gas discharged by a pressure reducing section) and/or the like is purposely discharged.

As can be known from the above, in the coating device according to the present invention, by performing the coating treatment to the lens substrate in a hermetically-sealed space, the surface of the substrate can be prevented from being adhered with dust and the like entered from the outside. Further, by being provided with the partial pressure reducer for reducing partial pressure of the volatile component derived from the coating material, unevenness in thickness of the coating film caused by high partial pressure of the volatile component can be reduced.

In the present invention, it is preferred that a containing tank for containing the coating material sprayed from the nozzle is provided. Since the excess coating material sprayed from the nozzle and not having been used for coating can be recovered to be reused as the coating material for later, consumption of the coating material can be remarkably reduced.

In the present invention, it is preferred that the treatment tank has a straight groove formed in the bottom thereof. The cross section of the groove may be a rectangular shape, a rectangular shape with corners thereof rounded, or a semicircular shape, instead of being limited to a particular shape.

The excess coating material sprayed from the nozzle and not having been used for coating flows into the bottom portion of the containing tank. Since the treatment tank has the straight groove formed in the bottom thereof, the excess coating material preferentially flows into the groove. By being temporarily contained in the groove, the excess coating material has less area exposed to the air, and therefore less volatile component is generated.

The present invention also provides a production method of a plastic lens including a spin coating process.

The production method of the plastic lens disclosed here includes a wet-coating process in which a coating material is coated by a spin coating method, and in the wet-coating process, the partial pressure of a volatile component of the coating atmosphere derived from the coating material is reduced.

Incidentally, it is required that the partial pressure of the volatile component is lower than the vapor pressure of the coating material under normal atmospheric pressure, although the partial pressure varies depending on the kind of the solvent. For example, in the case where a coating material containing a volatile component having a vapor pressure of 6000 Pa at 30° C. is used, the partial pressure of the volatile component is required to be reduced to lower than 6000 Pa in order to form a coating film at 30° C. By forming the coating film in an environment where the partial pressure of the volatile component even if is slightly lower than the vapor pressure, a high-quality coating film can be formed on the surface of the plastic lens substrate. Further, even in the case where the coating is successively performed to a plurality of plastic lens substrates, the high-quality coating film can be repeatedly formed regardless of the number of the plastic lens substrates to be coated by the coating device.

### Effect of the Invention

According to the present invention, it is possible to not only prevent dust from entering the treatment tank by sealing the treatment tank hermetically, but also reduce unevenness in thickness of the coating film in the case where the coating treatment is performed to a plurality of lenses.

### BRIEF DESCRIPTION OF DRAWINGS

FIG. 1 is a cross section schematically showing the configuration of a coating device according to an embodiment of the present invention.

FIG. 2 is a cross section schematically showing the configuration of a coating device according to another embodiment of the present invention.

FIG. 3 is a cross section schematically showing the configuration of a coating device according to further another embodiment of the present invention.

FIG. 4 is a cross section schematically showing the configuration of a coating device according to further another embodiment of the present invention.

FIG. 5 is a cross section schematically showing the configuration of a coating device according to further another embodiment of the present invention.

FIG. 6 is a cross section schematically showing the configuration of a coating device according to further another embodiment of the present invention.

FIG. 7 is a plan view schematically showing the configuration of the bottom of the treatment tank of the coating devices shown in FIGS. 5 and 6.

FIG. 8 is a plan view schematically showing the configuration of the bottom of a treatment tank of a coating device according to another embodiment of the present invention.

FIG. 9 is a plan view schematically showing the configuration of the bottom of a treatment tank of a coating device according to another embodiment of the present invention.

### BEST MODE FOR CARRYING OUT THE INVENTION

Although the preferred embodiments of the invention are described below, it should be understood that the present invention is not limited to these embodiments. Also, although the embodiments below are described using examples in which a primer layer, a hard coat layer, a protective film or the like is coated to various lens substrates, such as a plastic lens for spectacles, a coating device according to the present invention is not limited to be used to apply coating treatment to the lens for spectacles, but can also be used to apply coating treatment to various other substrates.

### (1) First Embodiment

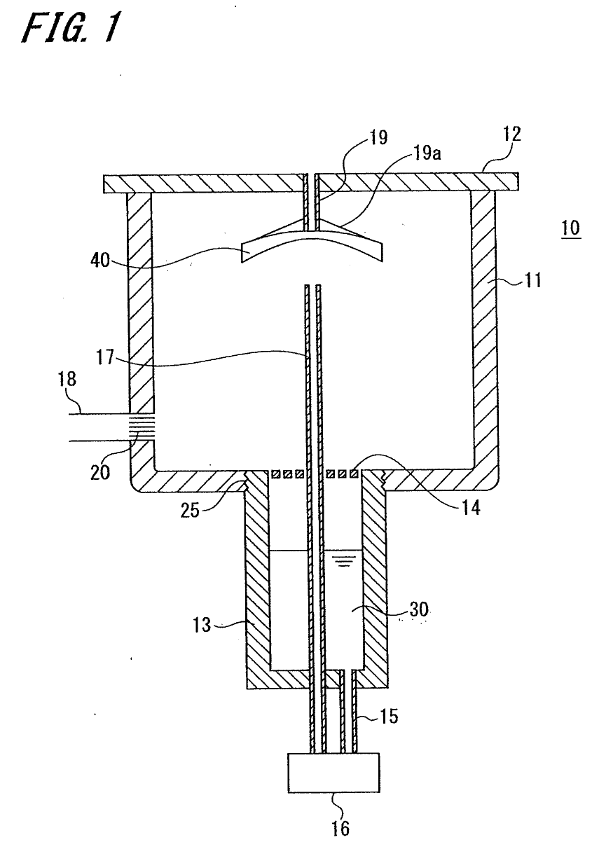

FIG. 1 is a cross section schematically showing the configuration of a coating device according to a first embodiment of the present invention. A treatment device 10 includes, for example, a substantially cylindrical treatment tank 11, a lid 12 covering an upper portion of the treatment tank 11 so that the treatment tank 11 is hermetically sealed, and a containing tank 13 connected to a lower portion of the treatment tank 11 to contain coating material. The containing tank 13 is substantially cylindrical having a radius smaller than that of the treatment tank 11, for example. Further, an upper opening of the containing tank 13 is connected to the bottom of the treatment tank 11, and it is preferred, but not required, that a net 14 is arranged in an opening provided between the treatment tank 11 and the containing tank 13 so that foreign matter, for example, does not enter the containing tank 13.

A substrate holder 19 for holding a substrate 40 such as a plastic lens for spectacles or the like, to which the coating treatment is applied, is arranged at substantially the center of the lid 12. In the present embodiment, a suction pad 19a is provided at a tip end of the substrate holder 19 to suck a surface opposite the surface to be coated of the lens, and thereby the lens 40 is held. Further, the substrate holder 19 is connected to an external rotation mechanism (not shown) so that the substrate 40 is driven to rotate at a predetermined rotation speed when performing coating treatment. Further, there is another possible configuration in which an external exhaust device is employed to draw gas through a through-hole formed inside the substrate holder 19, so that the holding force of the suction pad 19a is ensured.

Incidentally, the holding state of the substrate 40 is not limited to those shown in the drawings, but can be others. Further, it is preferred that the substrate holder 19 can be removed from the treatment tank 11 either alone or together with the lid 12, so that operation of attaching and detaching the substrate 40 can be performed outside the treatment device.

Further, a pipe 15 is connected to the bottom of the containing tank 13, for example, so that a coating material 30 contained in the containing tank 13 can be supplied to a nozzle 17 by a drive section 16 such as a motor. The nozzle 17 protrudes into the central portion of the treatment tank 11 from the drive section 16 through the containing tank 13, so that a tip end of the nozzle 17 faces the surface to be coated of the substrate 40.

Further, in the present invention, the treatment tank 11 is provided with a partial pressure reducer for reducing the partial pressure of a volatile component derived from the coating material 30. In the present embodiment, as the partial pressure reducer, an exhaust pipe 18 connected to an exhaust section such as a vacuum pump (not shown) is provided in a lower portion of the side wall of the treatment tank 11. The exhaust pipe 18 may be provided with a filter 20 for preventing plugging up.

When performing the coating treatment by the coating device 10, the substrate holder 19 for holding the substrate 40 is rotated by the rotation mechanism (not shown) while the gas inside of the treatment tank 11 is discharged through the exhaust pipe 18. Further, the coating material 30 is sprayed from the tip end of the nozzle 17 by the drive section 16. The coating material may be spayed in the form of liquid or mist. The coating material 30 is coated onto the surface to be treated of the substrate 40, and the excess coating material that has been used to coat the substrate 40 disperses and falls into the lower portion of the treatment tank 11 so as to be recovered into the containing tank 13 through the net 14.

Note that, although the containing tank 13 is provided to form a system for circulating the coating material 30 in the present embodiment, there is another possible configuration in which the containing tank 13 is eliminated, and the excess coating material is discharged without being circulated. In such a case, the coating material may be supplied to the nozzle 17 through a pipe from outside.

In the present embodiment, although the volatile component of the solvent of the coating material 30 is generated when performing coating treatment, the generated volatile component is discharged to the outside through the exhaust pipe 18 so as not to accumulate inside the treatment tank 11. Thus, vapor pressure of the solvent can be inhibited or prevented from becoming high. Further, in the case where the coating treatment is applied to a plurality of substrates 40, since vapor pressure of the solvent is less susceptible to change for each coating treatment, unevenness in thickness of the coating film of each substrate can be reduced.

Incidentally, the exhaust pipe 18 may be arranged at a position where the flow of the coating material is not prevented when performing the coating treatment while the coating material is sprayed from the nozzle 17, moves along the surface to be coated of the substrate 40, and then drops down. Incidentally, the exhaust section may stop performing the exhausting operation during the time while the coating material is actually being sprayed from the nozzle 17 to the substrate 40.

Further, the exhaust pipe 18 is preferably arranged at a relatively lower position of the treatment tank 11 in the case where the generated vapor is heavier than air, such as the vapor of an organic solvent, and is preferably arranged at a relatively higher position of the treatment tank 11 in the case where the generated vapor is lighter than air.

Although FIG. 1 shows a configuration in which the substrate 40 is held and rotated inside the treatment tank 11 with the surface to be coated thereof facing downward, and the coating material is sprayed from the nozzle 17 arranged on the lower side of the treatment tank 11, there is another possible configuration in which the coating material is sprayed to the surface to be coated of the substrate 40 from above. In a coating device in which the coating treatment is performed by spraying the coating material to the rotating substrate 40 from above, the partial pressure of the volatile component can also be inhibited from increasing by providing the exhaust pipe 18 as provided in the aforesaid embodiment. Thus, unevenness in thickness of the coating film can be reduced.

### (2) Second Embodiment

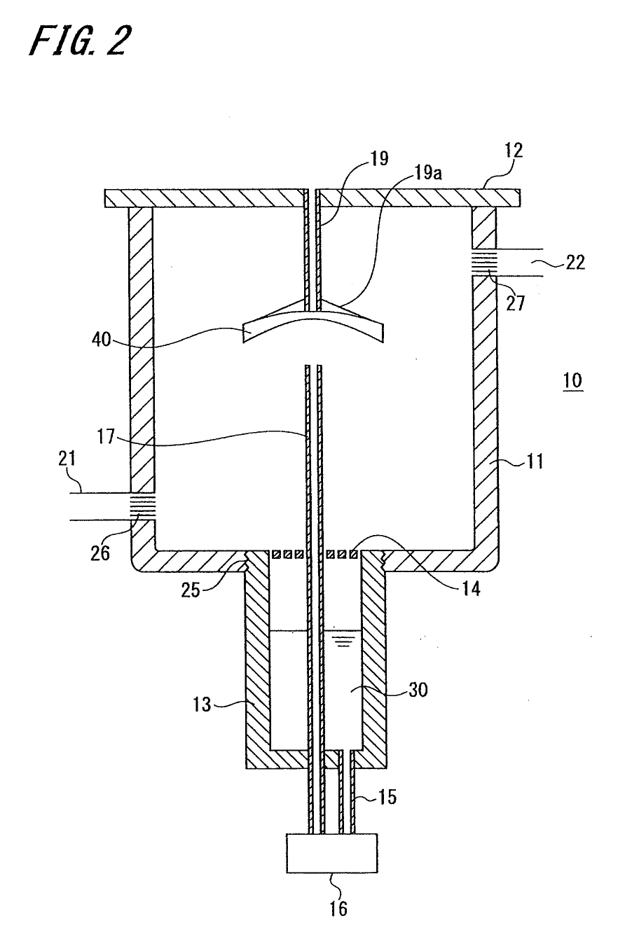

Next, a coating device according to a second embodiment of the present invention will be described below. FIG. 2 is a cross section schematically showing the configuration of a coating device according to the present embodiment. Note that, like components shown in FIG. 2 are denoted by like numerals as of FIG. 1 and the explanation thereof will not be repeated. In the present embodiment, in addition to an exhaust pipe 21, as the partial pressure reducer, provided in the lower portion of the treatment tank 11 similar to the first embodiment, an introducing pipe 22 is provided in an upper portion of the treatment tank 11. The introducing pipe 22 serves as a gas introducing section for introduced a gas (such as an inert gas, the air or the like) into the coating device 10 so that total pressure inside the coating device 10 is maintained constant. Since not only the partial pressure reducer, which discharges the gas inside the treatment tank 11, but also the gas introducing section are provided, the partial pressure inside the treatment tank 11 can be made more homogeneous. Thus, it is possible to form a coating film in a manner in which unevenness in thickness of the coating film for each coating treatment is reduced.

Incidentally, though not particularly limited, it is preferable that the positional relationship between the introducing pipe 22 and the exhaust pipe 21 may be suitably determined based on the relationship between the weight of the introduced inert gas and the weight of the gas vaporized from the solvent and the like intended to be positively discharged. For example, in the case where the weight of the introduced gas is greater than the weight of the gas vaporized from the solvent, the exhaust pipe 21 may be arranged in the lower portion of the treatment tank 11, and the introducing pipe 22 may be arranged in the upper portion; and in the case where the weight of the introduced gas is smaller than the weight of the gas vaporized from the solvent, the exhaust pipe 21 may be arranged in the upper portion of the treatment tank 11, and the introducing pipe 22 may be arranged in the lower portion. With such an arrangement, since the volatile gas derived from the solvent and the like is pressed by the introduced gas such as the inert gas, the volatile gas can be more easily discharged.

Incidentally, when introducing the gas such as the inert gas, air or the like, dust can be inhibited from entering by introducing the gas having passed through a filter. Thus, it is preferred that a filter 27 is arranged in the introducing pipe 22 as shown in FIG. 2. Further, the exhaust pipe 21 may also be provided with a filter 26 for preventing plugging up.

### (3) Third Embodiment

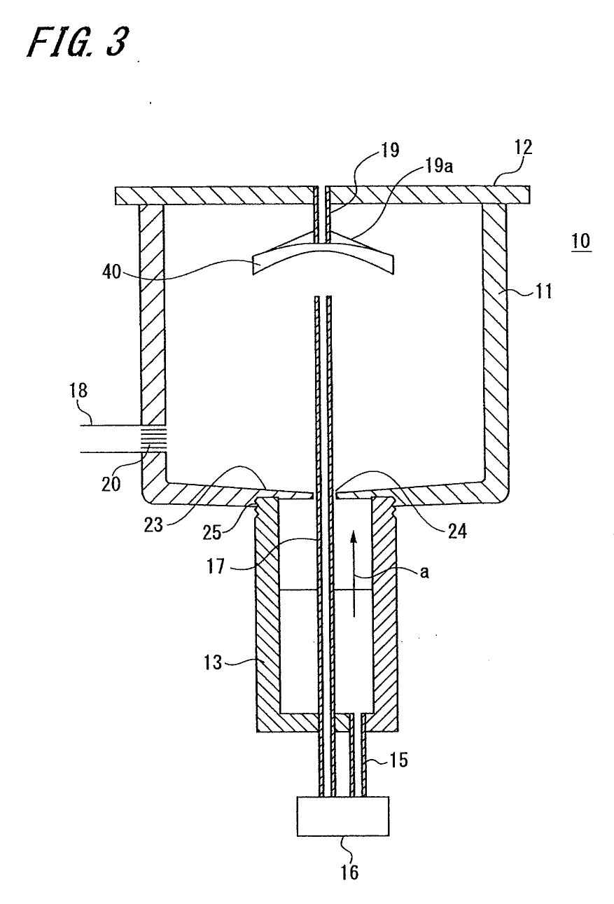

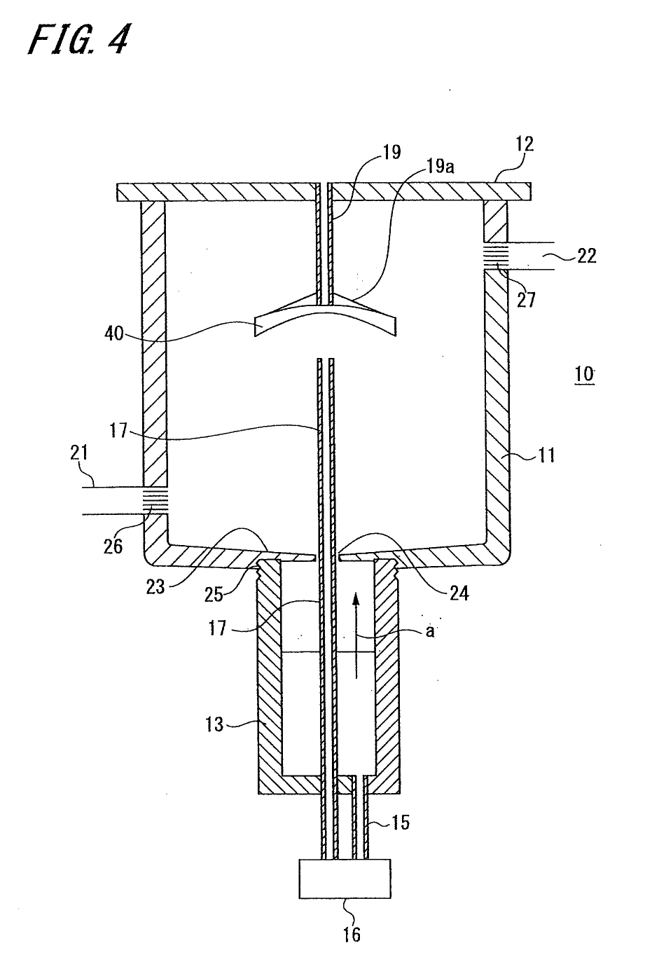

Next, a coating device according to a third embodiment of the present invention will be described below. The present embodiment is configured by replacing the net 14 arranged between the treatment tank 11 and the containing tank 13 of the coating device according to the first and second embodiments with a partition 23. FIG. 3 shows an example in which the present embodiment is applied to the coating device described in the first embodiment, and FIG. 4 shows an example in which the present embodiment is applied to the coating device described in the second embodiment. Note that, like components shown in FIGS. 3 and 4 are denoted by like numerals as of FIGS. 1 and 2, and the explanation thereof will not be repeated.

In the present embodiment, the partition 23 of the bottom of the treatment tank 11 for partitioning the treatment tank from the containing tank 13 has a funnel shape which is gradually recessed downward from the peripheral portion toward the center. Further, a hole 24 for letting the coating material 30 flow out is formed in a central portion of the partition 23. The size of the hole 24 is set such that the area of the hole 24 is as small as possible within a range that allows the excess coating material 30 flow into the containing tank 13 (i.e., within a range that allows the excess coating material 30 be recovered). Incidentally, the hole 24 may also be formed near the partition 23 to surround the nozzle 17, or be formed on one side of the nozzle 17, or a plurality of holes are dotted in the partition 23.

As described above, since the bottom of the treatment tank 11 is provided with the funnel-shaped partition 23 which inclines downward from the peripheral portion toward the hole 24 formed near the center, the excess coating material can be more easily recovered into the containing tank 13. As described above, by setting the area of the hole 24 as small as possible within a range that allows the coating material 30 flow out in a short time, the volatile component of the coating material inside the containing tank 13 can be remarkably inhibited from returning to the treatment tank 11 compared with the case where the net 14 is employed. As described above, by making the vapor of the solvent of the coating material 30 contained in the containing tank 13 harder to return to the treatment tank 11, the partial pressure of the volatile component inside the treatment tank 11 can also be inhibited from increasing during the period when the coating treatment is not being performed. Thus, with the present embodiment, in combination with the advantages achieved due to the provision of the partial pressure reducer and the gas introducing section, uniform coating film can be achieved more reliably in the coating treatment process.

### (4) Fourth Embodiment

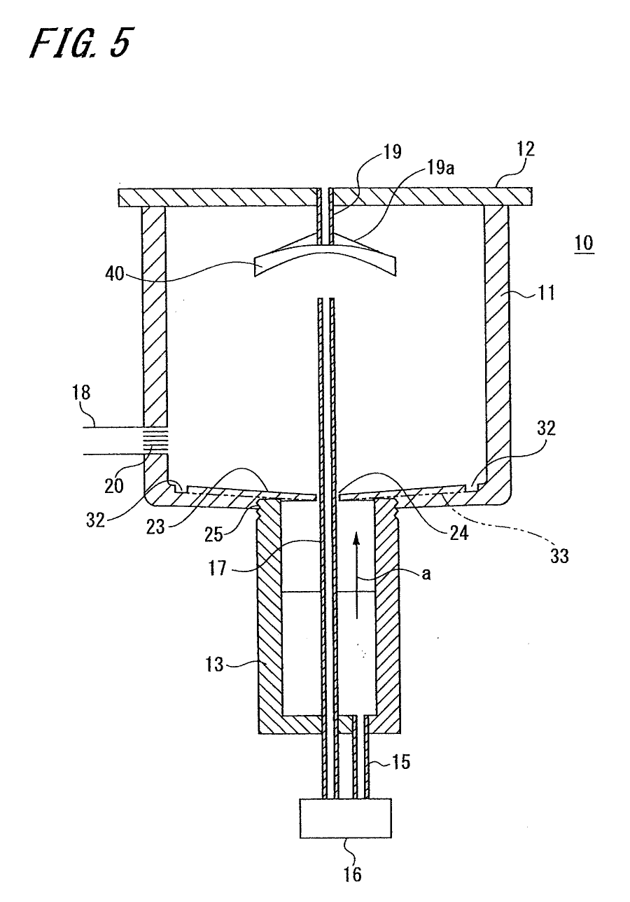

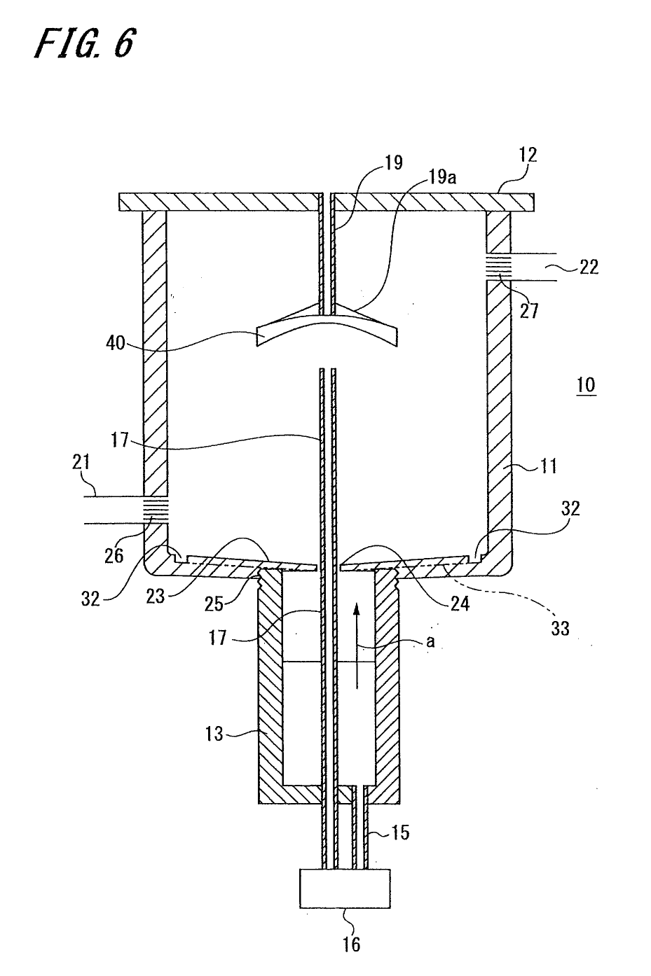

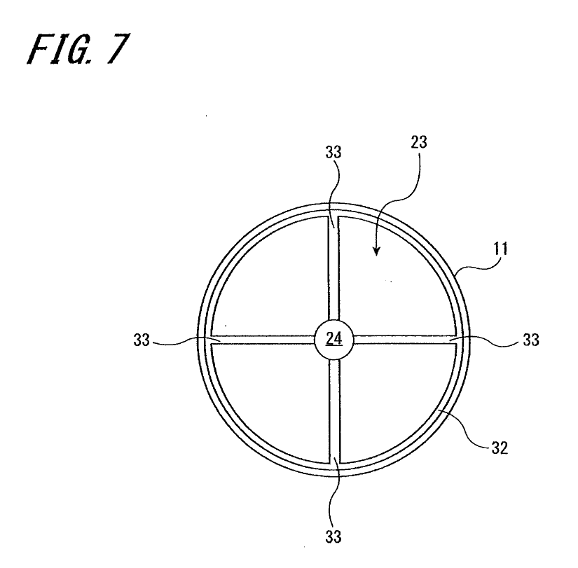

Next, a coating device according to a fourth embodiment of the present invention will be described below. The present embodiment is configured by forming straight grooves 31 in the wall surface on the side of the treatment tank 11 of the funnel-shaped partition 23 arranged between the treatment tank 11 and the containing tank 13 of the coating device according to the third embodiment. FIGS. 5 and 6 show the coating devices according to the present embodiment. Further, FIG. 7 is a plan view schematically showing the wall surface on the side of the treatment tank 11 of the partition 23 according to the present embodiment. Note that, like components shown in FIGS. 5 to 7 are denoted by like numerals as of FIGS. 3 and 4, and the explanation thereof will not be repeated.

In the present embodiment, a groove 32 having an annular shape in plan view and a recessed cross section and four straight grooves 33 are formed in the partition 23, which is the bottom of the treatment tank 11. The groove 32 extends along the dividing line between the bottom and the side wall of the treatment tank 11, and the grooves 33 each extend from the groove 32 toward the hole 24 formed at the center (i.e., the grooves 33 extend radially from the hole 24).

As described above, since the groove 32 extends along the side wall of the treatment tank 11, when performing the coating treatment, the excess coating material spun off and flowing down along the side wall of the treatment tank 11 can be recovered by the groove 32. Further, since the radially extending grooves 33 are connected to the groove 32, the coating material recovered by the groove 32 is guided into the hole 24 through the grooves 32. Further, the grooves 33 can also recover the excess coating material directly falling down to the partition 23 (the bottom) and guide the recovered the coating material to the hole 24. According to the present embodiment, since the excess coating material is reliably guided into the containing tank 13 through the grooves 32, 33, less excess coating material is accumulated on the other parts of the treatment tank 11 than the bottom (the partition 23). Since exposure area of the coating material on the bottom (the partition 23) is reduced, the volatile component derived from the excess coating material can be minimized.

With the present embodiment, the advantage of the partition 23 can be further increased, and uniform coating film can be achieved more reliably in the coating treatment process.

### (4-a) Modification 1 of Fourth Embodiment

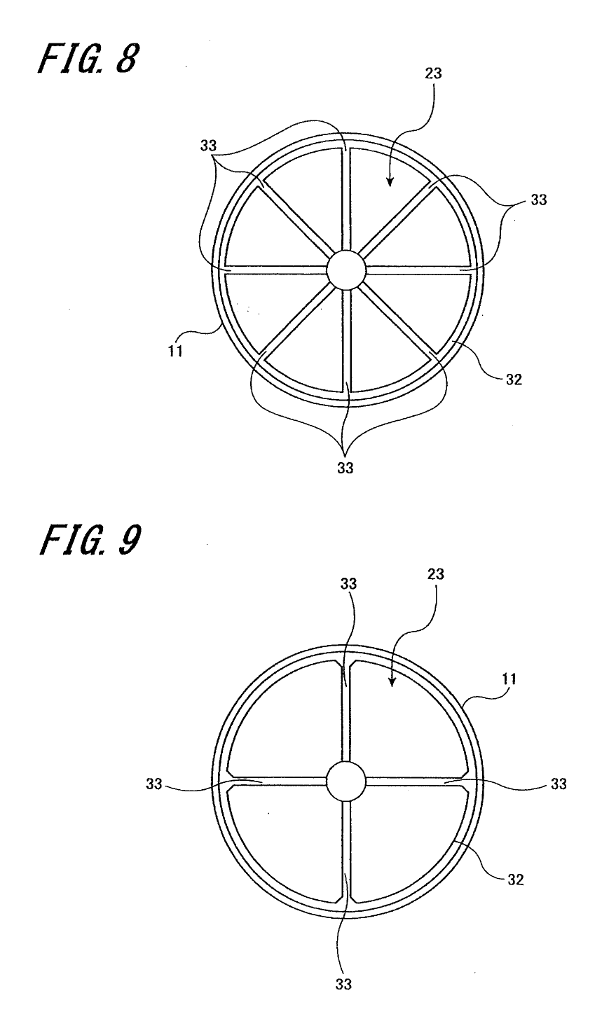

The aforesaid embodiment is described using an example in which the number of the straight grooves 33 arranged between the groove 32 and the hole 24 is four, and the four straight grooves 33 is arranged on the left, right, upper and lower sides of the hole 24 at an angular interval of substantially 90 degrees, however the number of the straight grooves 33 is not limited to four but may be, for example, six as shown in FIG. 8. Note that, like components shown in FIG. 8 are denoted by like numerals as of FIG. 7 and the explanation thereof will not be repeated. FIG. 8 shows an example in which six straight grooves 33 extend radially from the hole 24 at an angular interval of substantially 60 degrees. Thus, the number of the grooves 33 may be changed as long as they form a shape which allows the coating material flow more easily, and further, the width and cross section of the grooves 33 may be properly changed to allow the coating material flow more easily.

### (4-b) Modification 2 of Fourth Embodiment

FIG. 9 shows an example in which the corner of each of connection portions connecting the groove 32 and the grooves is cut to become Y-shaped so that the coating material flows more easily without accumulating in the connection portions connecting the groove 32 and the grooves 33. Note that, like components shown in FIG. 9 are denoted by like numerals as of FIGS. 7 and 8 and the explanation thereof will not be repeated. Thus, the shape of the groove 32 and the grooves 33 may be changed in various ways as long as the coating material fallen onto the partition 23 can be reliably guided to the hole 24 without remaining in the treatment tank 11. Although the corner of each of connection portions connecting the groove 32 and the grooves 33 is cut into a linear shape in the example shown in FIG. 9, the corner may also be cut into other shape, such as curve, as long as the coating material accumulated in the connection portions can be reduced.

The grooves 33 may also be curve-shaped instead of being radially formed for example, and the grooves 33 may be spirally-curved to fit the rotation direction of the substrate holder 19, or be ramified to fit the moving direction of the fallen excess coating material for example.

Note that, the examples shown in FIGS. 5 to 9 are described using an example in which the treatment tank 11 is provided with the containing tank 13 for containing the coating material, and the groove 32 and the straight grooves are formed in the partition 23 arranged between the treatment tank 11 and the containing tank 13, but the grooves 32, 33 are not necessary to be formed in the treatment tank 11 provided with the containing tank 13. For example, there is another possible configuration in which a discharge hole for discharging the excess coating material is provided in the bottom of the treatment tank 11, and the grooves 32, 33 are provided in the bottom of the containing tank 13 in the same manner so that the coating material flows more easily toward the discharge hole.

### (5) Fifth Embodiment (Production of Plastic Lens)

The coating device having the exhaust section as described in the fourth embodiment was used to successively produce 100 pieces of plastic lenses for spectacles, and the film thickness in the central portion of the lens was evaluated. The film thickness falling in the range of 2 μm-3.5 μm was evaluated as acceptable. An evaluation was successively performed to first five plastic lenses, and then a sampling evaluation was performed to the remaining plastic lenses. The result was shown in Table 1.

The lens was made of polycarbonate, and a hard coat liquid was used as the coating material for coating the lens. The hard coat liquid contained silica and acrylic resin, and the solvent was PGM (propylene glycol monomethyl ether). Coating treatment was applied to a convex face side of the lens.

A vacuum pump was used as the exhaust section when performing the coating treatment, and exhaust capability of the vacuum pump was 30 L/min.

When performing the coating treatment, spin coating rotation was 500 rpm for first 20 seconds and 1500 rpm for next 50 seconds, and the coating treatment was performed with the cycle of 60 seconds per piece.

The plastic lens having been subjected to the coating treatment was then subjected to a curing treatment by being irradiated with ultraviolet rays for 30 seconds.

As a comparative example, a coating device as described in the first embodiment except for having no exhaust section was used to successively produce 100 pieces of plastic lenses for spectacles, and the film thickness in the central portion of the lens was evaluated. The lens material, the coating material and the rotation condition were identical to those of the fifth embodiment.

The result was shown in Table 1. Incidentally, in Table 1, the unit of the film thickness is μm, and the film thickness falling in the range of 2.0 μm-3.5 μm is evaluated as “acceptable”.

TABLE 1

| Film Thickness (μm) | Example | Comparative Example |
|---|---|---|
| 1st | 2.5 | 2.5 |
| 2nd | 2.6 | 2.2 |
| 3rd | 2.4 | 1.9 |
| 4th | 2.5 | — |
| 5th | 2.3 | — |
| 30th | 2.5 | — |
| 50th | 2.6 | — |
| 80th | 2.4 | — |
| 100th | 3.0 | — |

As can be known from Table 1 that, in the example, the film thickness of the samples did not exceed the design value even 100 pieces of lenses had been successively produced. In the example, the increase of the film thickness of the samples was observed when near 100 pieces of lenses had been produced. This is because solvent component was reduced due to discharging of the volatile component (the solvent) of the coating material by the exhaust section, and therefore the viscosity of the coating material increases.

On the other hand, in the comparative example, the decrease of the film thickness of the samples was observed right after the successive coating treatment was started, and the film thickness of the third sample was lower than the design value. This is because the treatment tank was full of the volatile component, and therefore the coating material becomes less likely to adhere to the surface of the plastic lens.

As can be known from the description above, with the present invention, the volatile component of the solvent derived from the coating material can be prevented from excessively existing in the treatment tank, namely, the partial pressure of the volatile component can be maintained in low level. Thus, uneven film thickness, thin film thickness and unexpected film thickness distribution caused by high partial pressure of the volatile component can be reliably inhibited.

Unexpected film thickness distribution is undesirable when performing surface treatment to an optical product where high precision is required, and therefore it is grateful that thin film thickness, uneven film thickness and unexpected film thickness distribution can be inhibited with the present invention, and a coating film of predetermined thickness can be reliably achieved.

It is to be understood that the present invention is not limited to the embodiments described above, and various modifications and applications can be made without departing from the spirit of the present invention described in the claims.

### EXPLANATION OF REFERENCE NUMERALS

10 coating device, 11 treatment tank, 12 lid, 13 containing tank, 14 net, 15 pipe, 16 drive section, 17 nozzle, 18 exhaust pipe (partial pressure reducer), 19 substrate holder, 19a suction pad, 21 exhaust pipe (partial pressure reducer), 22 introducing pipe (gas introducing section), 23 partition, 24 hole, 30 coating material, 32, 33 groove, 40 substrate

1. A coating device comprising:
a treatment tank capable of being hermetically-sealed;
a substrate holder contained in the treatment tank and arranged in a rotatable manner;
a nozzle for spraying a coating material to a substrate held by the substrate holder; and
a partial pressure reducer for reducing partial pressure of a volatile component derived from the coating material inside the treatment tank.

2. The coating device according to claim 1, wherein the partial pressure reducer is an exhaust section.

3. The coating device according to claim 1, wherein the treatment tank is provided with a gas introducing section for introducing a gas therein.

4. The coating device according to claim 3, wherein the gas is introduced from the gas introducing section through a filter.

5. The coating device according to claim 1, wherein the treatment tank has a straight groove formed in a bottom thereof.

6. The coating device according to claim 1, wherein the treatment tank is provided, at a lower portion thereof, with a containing tank for containing the coating material sprayed from the nozzle.

7. The coating device according to claim 6, wherein a funnel-shaped partition is provided between the treatment tank and the containing tank.

8. The coating device according to claim 6, wherein a partition is provided between the treatment tank and the containing tank, and a hole allowing the coating material flow out is formed in a portion of the partition.

9. The coating device according to claim 7, wherein a wall surface on the side of the treatment tank of the partition is the bottom of the treatment tank, and a wall surface on the side of the containing tank of the partition is a ceiling of the containing tank.

10. A production method of a plastic lens comprising:
a wet-coating process in which a coating material is coated on a surface of a plastic lens substrate by a spin coating method,
wherein, in the wet-coating process, partial pressure of a volatile component of the coating atmosphere derived from the coating material is reduced.
